(19) United States
(12) Patent Application Publication
(10) Pub. No.: US 2004/0181422 A1
(43) Pub. Date: Sep. 16, 2004

(54) Economic analysis and planning model for deconstruction of large scale industrial facilities

(76) Inventor: Robert J. Brand, Philadelphia, PA (US)

Correspondence Address: Mark D Simpson, Synnestvedt & Lechner, 2600 Aramark Tower, 1101 Market Street, Philadelphia, PA, 19107-2905, US

(21) Appl. No.: 10/488,652

(22) PCT Filed: Sep. 9, 2002
(86) PCT No.: PCT/US02/28636

Related U.S. Application Data
(60) Provisional application No. 60/318,071, filed on Sep. 7, 2001.

(51) Int. Cl. G06F 17/60

(52) U.S. Cl. 705/1

(57) ABSTRACT

An economic analysis model (see FIG. 1) including a suite of software based modules designed to assist deconstruction and recycling of large scale industrial facilities at every stage of the effort including but not limited to assessment (102) and pricing, acquisition, production planning, cost reduction and revenue enhancement, as well as updating a historical database to store data to these stages. The invention is particularly useful with deconstruction projects involving large-scale, complex industrial facilities such as ships, refineries, floating oil rig platforms, chemical and nuclear plants.

### CROSS-REFERENCE TO RELATED APPLICATIONS

This application is based on, and claims priority to, U.S. Provisional Application No. 60/318,071, filed Sep. 7, 2001.

### FIELD OF THE INVENTION

The invention concerns an economic analysis model, implementable in the form of software on a computer system and designed to assist in the economic evaluation, planning and scheduling for the deconstruction and recycling of large scale, complex industrial facilities such as ships, refineries, floating oil rig platforms, chemical plants, nuclear power plants and the like.

### BACKGROUND OF THE INVENTION

Each year, 4,000 ships, several hundred oil rigs, dozens of complex industrial installations and dozens of sites involved in environmental accidents require deconstruction, recycling and environmental containment. The ship deconstruction and oil rig deconstruction projects, by themselves, are a $50,000,000,000 per year sector of this industry.

Unfortunately, the scale of individual enterprises currently engaged in the tasks of deconstruction of such complex industrial facilities is relatively small and, therefore, the market is disorganized, inefficient and the economic stimulus propelling it is limited. The need for expert systems in the form of software based decision tools to assist this industry by providing an efficient system which minimizes costs and maximizes revenues while meeting the primary objective of deconstructing these facilities and recycling the components and materials to the extent possible is substantial.

An economic analysis model useable by entrepreneurs in the course of performing and building their deconstruction businesses will overcome the historic lack of an organized market, promote greater efficiency within the industrial sectors of the market and substitute a growing set of cost rated, scientifically valid, sustainable practices upon which to build sustainable enterprises that serve a growing industry.

Such economic analysis models, in the form of expert decision software or expert systems, will assist this industry in solving the production and scheduling problems it faces in an efficient manner and will facilitate the development of a database from the practice of the entrepreneurs within the industry which will be used to constantly improve the efficiency of and increase the knowledge within the industry. An economic analysis model which assists enterprises at each stage of their work, namely, evaluation and pricing of an individual job; identification of best practices for environmental containment; the apportioning of capital and labor force; qualifications of an entrepreneur and a worksite; development of appropriate health and safety procedures and training efforts for each job; choice of innovative and alternate production processes to drive down costs; identification of recycling or value added recycling and reuse opportunities to enhance revenue; development of environmentally sound waste disposal procedures; and the establishment of overall cost accounting systems to guide the technical and business sides of an enterprise will substantially aid the creation of a sustainable deconstruction and recycling industry.

Without economic analysis models providing expert decision tools, the deconstruction and recycling industry will continue to see a high rate of enterprise failure, a variety of inefficient, ill-advised strategies employed by the owners of facilities needing deconstruction to avoid the uncertainty of an unstable sector, as well as the accompanying environmental damage and health hazards to workers and host communities. Without economic analysis models to support a more rational and efficient deconstruction enterprise, there will be continuing environmental damage exacerbating an already serious problem. Economic analysis models also offer regulators a set of analyses that will support the level of regulation and private entrepreneurship that is essential for individual and societal success.

### SUMMARY OF THE INVENTION

The economic analysis model according to the invention comprises a suite of software based modules designed to assist deconstruction and recycling of large scale industrial facilities at every stage of the effort including but not limited to assessment and pricing, acquisition, production planning, cost reduction and revenue enhancement, as well as updating a historical database to store data pertaining to these stages.

The model provides a method for analyzing the economic feasibility of deconstructing or refurbishing a large scale facility, the method including the steps of identifying and enumerating the relevant characteristics of the facility to be deconstructed or refurbished; identifying and enumerating the capabilities of an organization tasked to perform the deconstruction of the facility; deriving a set of options for deconstruction or refurbishment based upon the relevant characteristics of the facility and capabilities of the organization; calculating the costs associated with each option; calculating the revenue associated with each option; and comparing the costs and revenues to rank the options relative to one another.

The model is designed to provide expert assistance for a deconstruction and recycling enterprise or set of enterprises at every step of their ventures, offering the entrepreneurs expert decision assistance and engineering support to assure an environmentally sound, efficient, health and safety conscious business application to deconstruction, recycling and environmental containment tasks.

The economic analysis model according to the invention can be embodied in a complex set of algorithms and associated data that describe in detail the invention, which comprises a series of steps for recycling a large scale industrial facility such as a ship, an oil platform or a refinery, and using and updating a historical database to assist in the process. When the results of performing the steps of the present invention are displayed via a spread sheet, each row of the spread sheet describes the cost of a specific step of ship recycling and each column represents a set of data observations arranged into categories of low, medium and high cost. When adapted specifically for marine applications, the present invention functions for ship deconstruction and recycling, ship repair and overhaul, as well as oil rig platform decommissioning and recycling. It also can be used in any complex problem involving environmental remediation and is equally applicable to land based installation deconstruction such as the deconstruction of powerplants (nuclear as well as fossil fuel), refineries, chemical plants, mines, junkyards or other waste disposal sites.

The model is designed to be continually disaggregated, breaking each formula row and observational column into more detailed component steps. The process of creating new disaggregated steps may be automatic or can be user defined. Each row formula describes the associated capital needs, environmental problems, safety and health standards, labor force training and recycling revenue opportunities associated with each step of deconstruction. For each step, the model displays the appropriate output data concerning the low, midrange and high cost estimates associated with the step.

In an example using a marine application, the model begins with the input of a description of the ship. At the gross level, the description is a simple classification of the size and the type of ship, e.g., tanker, container ship, bulk carrier and the like. At its more sophisticated, detailed level, the ship description involves use of a comprehensive survey carried out onboard the ship by a survey instrument, e.g., manual inspections with data recorded electronically, and/or imaging of the ship and storage of the imaging data electronically. Information from the survey instrument is combined with historic records of the ship to identify environmental issues, health and safety concerns and potential recycling revenues. The survey instrument is developed from a variety of sources and the stored data from the survey continues to be refined as more data becomes available.

The model then uses input data describing the proposed site of recycling, the data characterizing the recycling yard by categories of capital equipment, labor force skills, environmental containment resources and access to advanced technology. The baseline cost structure of the recycling site and enterprise are also captured in this step.

Using the ship and recycling yard data the model then guides the user through several sets of questions arranged by production planning topic. The topics include, for example, environmental containment, worker health and safety, including training requirements, recycling opportunities and application of advanced technology.

Filling out each of these branching logic questionnaires allows the user to estimate the costs and resources necessary to successfully deconstruct and recycle the ship, or repair the ship. The model guides the user based upon the characteristics of the ship and characteristics of the yard described by the initial input analyses. The model allows only the options of a step that match the resources defined as available at the site and, therefore, helps a user understand the production options that are possible within the constraints defined.

The economic analysis model is compatible with a Virtual Reality Ship Model (VR model), which is preferably a separate software program that will serve as a “front end” to the economic analysis model to provide a virtual reality picture of each room and corridor of the ship to assist in the capture of data needed to describe the ship. The VR model can be analyzed using vertical and horizontal movements within a deck and between decks of the ship. The VR model can also isolate individual systems on the vessel. In addition to the virtual reality pictures of the ship, all databases concerning the blueprints, wiring diagrams, repair records and other relevant data will all be added to the VR model in a descriptive notes sections. The VR model will be used during all of the simulation inquiries allowing the virtual identification and tagging of parts, rooms, zones and other aspects of the ship. Use of the VR model is expected to decrease the need for an actual physical survey of the ship.

The economic analysis model is also compatible with various state-of-the-art, off-the-shelf production management software packages. The output of the model is an analysis of all the decisions made by the user and displays them as alternatives in the production management model facilitating the resource allocation and budgeting decisions by the ship recycler.

Combined use of the economic analysis model along with the VR model and production management software will assure that an enterprise is aware of and has the opportunity to comply with the highest environmental, labor, health and safety standards, as well as providing the flow of information needed to minimize costs and maximize recycling revenues. Repeated use of the models allows users to learn from past performance in order to plan and execute more efficient operations, allocate resources and manpower more efficiently, recognize more effective investments and provide an informed choice of vessels to deconstruct. Because the models will be used as part of an ongoing research and development process within the industry, use of the models will provide an industry wide standard enabling enterprises to pool their knowledge to recognize, emulate or even exceed best practices on an industry wide spectrum.

### BRIEF DESCRIPTION OF THE DRAWINGS

FIG. 1 is a flow chart showing the various modules comprising the economic analysis and planning model according to the invention;

FIG. 1A is a flowchart giving an overview of the process from beginning to end;

FIGS. 2-6 are flowcharts that follow the example process described in FIG. 1A from beginning to end, as follows:

FIG. 2 is a flowchart commencing with data regarding the facility being input to a project database;

FIG. 3 is a flowchart that picks up with the analysis of potential deconstruction sites;

FIG. 4 is a flowchart commencing with the labor force of a first qualified site being analyzed;

FIG. 5 is a flowchart commencing with a determination being made as to whether or not both the facility and the site chosen are ready to begin the deconstruction process; and

FIG. 6 is a flowchart commencing at the cutting and/or demolition process.

### DETAILED DESCRIPTION OF A PRESENTLY PREFERRED EMBODIMENT

The economic analysis model for production planning and scheduling is designed to track a ship, oil rig platform, refinery, power plant or other complex industrial facility from the time a decision is made to decommission the asset and dispose of it in an environmentally safe manner until the completion of those tasks. The model depends upon a user's ability to utilize a set of assessment instruments to provide information to the model which then analyzes the information to provide feasible choices in view of the specific problems presented by the facility, capital equipment and resources available for deconstruction, the training level and skills of labor force available, best environmental practices and environmental regulations that are applicable to the facility and the site of work as well as the current state of knowledge concerning innovative production processes and recycling and reuse markets.

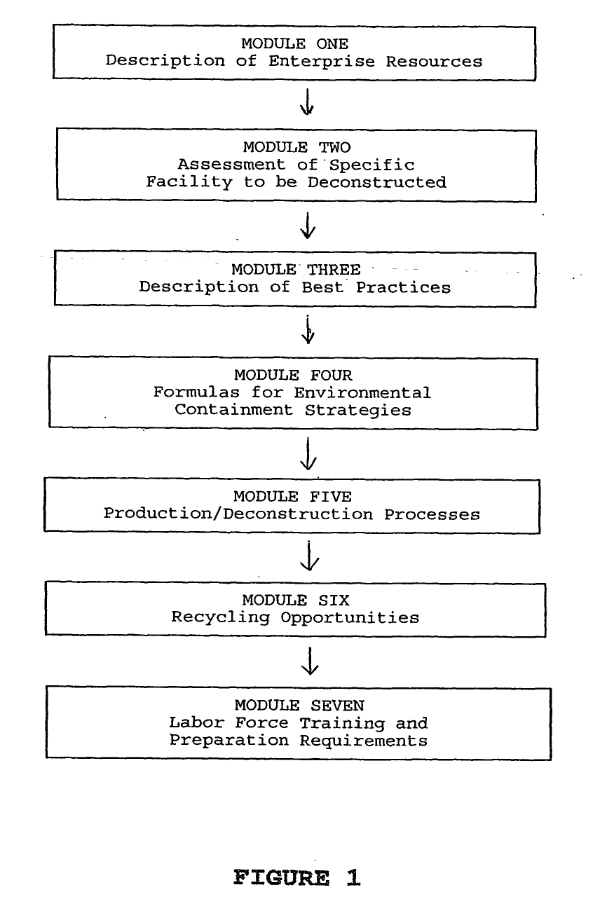

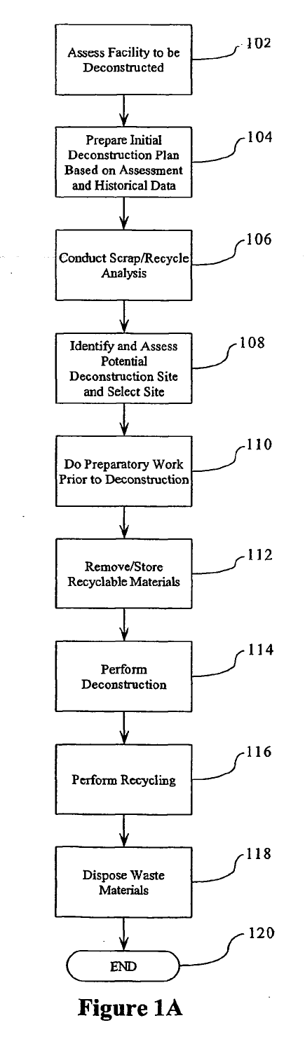

The economic analysis model according to the invention can best be understood as a set of interrelated, but separately performed steps for each function or task arranged into relational, functional modules that track the deconstruction of a complex facility. The modules are described below with reference to FIG. 1.

Module One is a description of enterprise resources. In this module, the user assembles data by responding to a set of on-line questionnaires covering the resources and configuration of the organization performing the deconstruction. For a ship deconstruction, for example, this would include a description of the shipyard where the deconstruction is to take place, including such factors as the characteristics of the labor force including its training and experience, capital equipment planned for use in the deconstruction effort, local, national and international toxic material disposal regulations. After inputting information concerning the specific characteristics of the shipyard (or other organization), the output of the model includes a cost structure for each resource in each category and a set of notations of best practices for toxic material decontamination or disposal of environmental hazards.

Factors specific to the deconstruction of a particular type of installation are accounted for in Module One. For the marine application example mentioned above, specific factors include issues of dry dock capacity, cutting instruments and technologies, cranes by weight capacity, containment fields, labor force certifications, alternatives to dry docking, location and related towing charges, local environmental requirements, permitting processes, etc. All of these factors have specific cost structures each of which affects the ability of an enterprise, such as the shipyard, to successfully deconstruct a specific installation. With user-provided data, Module One prepares a simple pro form a description of the capabilities and related costs of an enterprise for the deconstruction of an installation. This pro form a description can be customized by the user and serves as a guidepost for feasible deconstruction projects by an enterprise.

Module Two performs an assessment of the specific facility (ship, refinery, oil rig platform, etc.) scheduled for deconstruction. Preferably, this module has at least two levels of detail. The first is a simple analysis of the requirements for deconstructing the subject installation compared to inputs described in Module One. The level one process describes the expected issues, e.g., levels of environmental contamination, advanced industrial processes for an installation of the size, use history and complexity of the subject installation to provide a first cut feasibility screening for the project.

Given this first cut feasibility screening, Module Two is then ready for its second level which includes a complete survey of the installation, level-by-level, room-by-room, which identifies potential environmental and work process problems and begins calculating costs and revenues of a successful operation. In addition to the actual survey, Module Two is designed to incorporate an analysis of historic maintenance logs, repair documents, architectural documents and other records which will be incorporated into an associated CAD/CAM program. Module Two is also compatible with a virtual reality model of the installation which will be overlaid with all the data found through categorization, survey and analysis of historic documents.

From Module One and Module Two the model derives a simple feasibility analysis which describes the potential cost parameters of the enterprise to successfully deconstruct the installation being analyzed. Outputs from an analysis of these two modules will include a listing of expected issues, a range of historic costs for this user, a range of historic costs for all users, a range of expected revenue for this user and all users, and a range of major obstacles that the enterprise will have to solve to match its own resource capabilities to the requirements of deconstructing the subject installation.

Module Three of the suite describes best practices by issue of concern. This module presents the expected data for remediation and deconstruction of the subject installation from a data base of all observed deconstructions of similar installations. For each area of concern, alternative best practices will be documented based upon high, mid-range and low costs. For each best practice Module Three presents information on costs, revenue, complexity of remediation or deconstruction, environmental containment needs, labor training and skills needs for this structure and range of recycling products. This best practices catalog will allow the enterprise to compare the user's own methods of work and analysis to an existing database derived from all users and from ongoing analysis of research and development in the field.

Modules Four through Seven are specific, guided expert planning modules covering environmental, production/deconstruction processes, recycling opportunities and worker health and safety preparations. Each of these modules is designed around a set of branching logic questionnaires which are specified to the resources of the enterprise and the specific requirements of the installation to be deconstructed.

Certain characteristics of these modules should be noted. First, all formulas used in the modules are stand-alone cost/revenue projections using known formulas/techniques for such projections. Costs are expressed as a sum of the application of capital and labor to accomplish a task, offset by accompanying revenues from the task, with the opportunity to share costs of capital and labor force training among several tasks. Each term stands on its own. All of the terms essential for a task make up a formula.

In each formula, there are computations of potential cost-savings and revenue generation based on innovative production methods and the actual, state-of-the-art markets for materials and other factors, based on well-known computational techniques.

While each formula can be derived and developed independently, all formulas are both integrated and additive. The quality of formula integration allows costs or investments in a task to be shared between steps using identical or similar resources, thus, encouraging more precise production planning and investment by an enterprise. The additive quality of the formulas allows an enterprise to assess the feasibility or profitability of an opportunity to deconstruct an installation through combined analysis of all formulas and a specific knowledge of clusters of costs or resource burdens which exceed industry norms or specifications that are user designed to assure effective operation.

Each module is designed so that each independent formula can be calculated. Therefore, the inability of an enterprise to effectively price or plan one element of deconstruction does not prevent the user from problem solving and utilizing the remaining full capabilities of the suite of modules. In this way, enterprise problems are isolated for further analysis and for solution while the user continues to develop an understanding of the resources necessary to apply to the overall project (ship, oil rig, contaminated building site).

Module Four is a series of steps concerning environmental containment strategies. The module can be embodied in specific formulas for best practices for treatment and decontamination of PCBs, lead, mercury, and dozens of other substances. For each substance high, mid-range and low cost processes and total costs are presented. The user is presented with alternatives available given the enterprise's resource for each environmental contaminant. The module preferably uses branching logic questionnaire script which guides the user to provide data that allows the model to calculate costs and revenue for each contaminant including specific equipment and capital costs, disposal costs, labor costs and transportation and other costs. The module also notes special requirements for containment fields and alternative technologies available for containment. Finally, the model looks at local, national and international requirements for safe and effective disposal of contaminants.

Module Five examines the production/deconstruction processes and the sequencing of alternative production processes. This module begins with alternatives available given the enterprise resources, the characteristics of the installation to be deconstructed and the environmental challenges posed and allows the user to establish baseline costs for decontamination. The module data assists the user in analyzing alternative production processes and sequencing given enterprise resources. The model's database will constantly be updated and always contain cutting-edge options and their resource requirements. The branching logic questionnaires used to solicit data allows users to identify cost and revenue for each step of deconstruction and recycling, including capital equipment, labor costs and disposal costs.

Module Six documents recycling opportunities that are present in a deconstruction process. Based upon the analysis of the installation and existing commercial and research databases, the module identifies expected part lists and specific parts and condition as identified in the Module Three survey. The module then presents branching logic alternatives for the steps to remove a part while retaining its value, the cost of such removal, value added steps for increasing the revenue derived from such parts and a set of cautions concerning hazards associated with recycling efforts. Each analysis is done part by part based upon the user's full use of the capabilities of the model. The module also presents the existing prices in local and global markets for the parts under discussion.

Module Seven combines all of the analyses in previous modules to enable the enterprise to identify labor force training and preparation requirements to deconstruct the installation being analyzed. This module includes training requirements, protective equipment and gear requirements and a set of competency-based analyses to build the enterprise capability and the capability of the labor force to attack these problems.

Additional modules of the economic analysis model module suite specific may include enterprise management, engineering and planning costs and enterprise finance costs.

Additional modules of the economic analysis model module suite specific to marine applications may include ship or oil rig towing costs, vessel or structure storage costs, vessel rigging prior to commencing work costs, runoff containment costs and preparation for hot work costs including tank cleaning, removal of oil filled piping, removal of oil filled machinery, drainage of oil and break couplings.

In addition, for marine applications, bilge and ballast water disposal options are described in a module as well as a range of housekeeping costs in a module on the debris, sewage tanks and large diameter pipe cleaning.

A specific module can analyze costs and revenue specific to using the vessel or marine structure as an underwater reef, after decontamination. This module adds to the general modules specific reefing cutting requirements, specific diver safety remediation requirements efforts, specific needs to remove certain equipment, additional transport requirements and specific sinking costs.

The overall outputs of the entire suite of modules include individual component analyses as described above and a composite and aggregate cost/revenue analysis, a timeline for deconstruction, a management plan for deconstruction, a recycling strategy designed to maximize revenue and create necessary markets, a bidding analysis for assisting an enterprise in determining feasible bidding on specific installations, environmental compliance reporting forms, worker health and safety compliance reporting forms, community accountability monitoring reports, research databases additions, special studies including public research and development as well as proprietary research and development efforts, an overall feasibility analysis and an overall production planning and resource management description of the enterprise. These outputs are prepared as stand alone reports or as part of industry standard, off-the-shelf project planning and management software for complex industrial processes.

Example of Model Use in a Marine Application

Using this suite of modules in a marine application, a ship recycler first describes its capabilities, identifying the size of its enterprise, drydock, associated capital equipment, labor force qualifications, as well as requirements for environmental disposal and permitting. This description includes the cost structure and specific costs of each element of the enterprise, enabling the application of the costs to a prospective project.

The user then enters the specific characteristics of the ship to be evaluated. The first screen of this effort determines the technical feasability of deconstruction by the enterprise. If the ship clears this first hurdle, then the model guides a user through the ship, room-by-room to identify a comprehensive set of issues and steps to successfully deconstruct and recycle the ship.

With these issues identified and quantified, the user then develops a four-track process of planning the efficient deconstruction by analyzing the environmental, production processes, health and safety measures and recycling potential for the ship. The user combines these analyses to make an efficient plan for the recycling enterprise.

The plan for recycling covers the process of moving and securing the ship, as well as creating the containment fields around the ship as necessary to commence work. The plan then leads the recycler through the production steps of removal of hazardous materials and the removal of all parts of value.

Once the ship is cleaned and parts of value are in a recycling environment, for example, refurbishing or auction marketing, the production plan guides the enterprise through the cutting, materials separation and assembling of scrap products. The production plan includes tasks such as cleaning of the work site and preparation for the next project, including safety and environmental testing and equipment, tool and gear maintenance.

With the economic analysis model according to the invention, an enterprise can make rational decisions concerning bidding, choice of projects and execute a planned approach to cost reduction and revenue enhancement. Repeated use of the model on successive projects enables the user to refine methods, drive down costs and increase revenues in an enterprise while producing sound environmental results.

FIGS. 1A and 2-6 are flowcharts illustrating an example of the process of the present invention used to plan and perform the deconstruction of a facility to be deconstructed (“facility”) at a particular deconstruction site (“site”). By continually accessing and updating both a project database (specific to the project under study) and a historical database during the process, users of the system have the benefit not only of projections based upon past experiences with similar facilities at similar sites, but also the ability to revise cost estimates and track and compare actual costs versus estimated-costs on an on-going, essentially real-time basis.

FIG. 1A is a flowchart illustrating an overview of an example process from beginning to end. At step 102, the facility to be deconstructed is assessed and detailed information regarding the facility is stored in the historical and project databases. At step 104, the assessment data is compared with other historical data and an initial deconstruction plan is prepared. At this point in the process, a user of the system can view a display and/or read a printout itemizing the various aspects of deconstruction of the facility and estimated costs pertaining thereto. At step 106, a scrap/recycle analysis is performed by identifying goods/materials appropriate for scrap and/or recycling, comparing the goods/materials with historical data regarding costs and procedures involved in scrapping and/or recycling the goods/materials, and determining whether it would be most appropriate to scrap or recycle the goods/materials.

At step 108, based upon the above information now stored in the project and historical databases, the system compares the capability of potential deconstruction sites with the needs and requirements of the facility under consideration for deconstruction. At step 110, after a suitable site has been selected, preparatory work that must be done prior to the deconstruction process is performed. This may include training a labor workforce, obtaining certifications that are required, obtaining protective equipment and materials or machines needed for the process, towing the structure (in the case of a ship or other floating structure) to the location.

At step 112, waste materials are identified, cataloged in a waste inventory and inventoried and, to the extent possible at this time, removed and stored.

At step 114, the deconstruction process is essentially completed. This may involve what is referred to as “hot work”, which is any work that can produce a heat or a spark, for example, working with blow torches, electrical equipment, or grinding tools. This process is performed late in the procedure so that hazardous materials, flammable fuels and oils, and the like can be fully removed before it proceeds. If the facility being deconstructed is a ship, and it has been determined that the hull of the ship will be “reefed” (pulled out to sea and sunk for the purpose of artificial reefing), then the facility is prepared for reefing using known techniques.

At step 116 the complete list of recyclables is examined and analyzed and determinations are made as to specifics as to how the recycling will occur, at step 118, the list of waste materials is analyzed and the specific methods appropriate for disposal of the waste material are carried out, and at step 120 the process ends. Throughout the process, the historical and project databases are updated with new information obtained during the process.

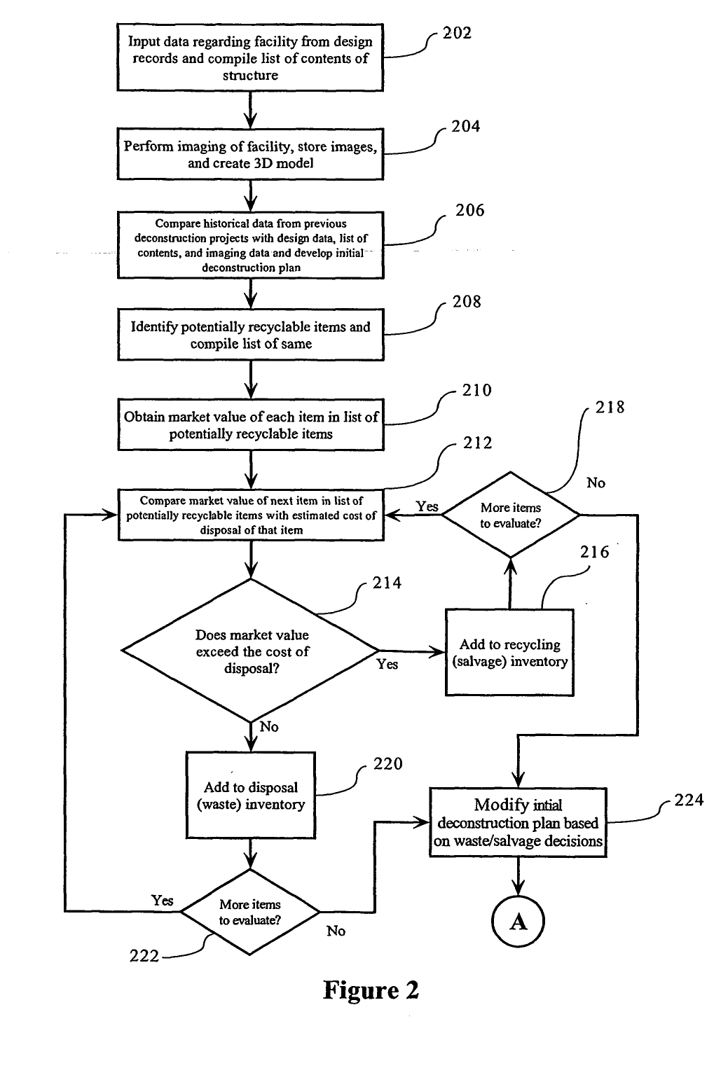

FIGS. 2-6 are flowcharts that follow the example process described in FIG. 1A, from beginning to end. Referring first to FIG. 2, at step 202, data regarding the facility is input to a project database, which is simply a database for storing data specific to the particular project being performed. This input data can be derived from any or all of design records, blueprints, wiring diagrams, fueling and refueling records, purchase orders and the like. Any source of records which will allow the identification and itemizing of the goods, materials, and other data relevant to deconstruction of facilities is used for this process so that a detailed listing of these materials and goods will be available. At any time during the process, it is understood that data derived and placed in the project database may also be input to a historical database for all projects so that the information can be used by others in the future.

At step 204, imaging of the facility can be performed to store images of the facility for use during the process. From the imaging data, 3D models can be created using CAD/CAM systems as is well known. By imaging and preparing 3D models of the facility, visits to the facility can be minimized, thereby saving time. Further, as the process proceeds and HAZMATS, recyclable items, items to be disposed of, etc. are identified, the 3D images can be updated to label or designate these items for appropriate disposal/recycling, etc. This will, for example, give the user of the system an inventory as to where in the facility particular items of this kind are located and serve as a reminder that recycling/salvage/disposal procedures must be followed with respect to these items. All this information is added to the project database.

At step 206, the historical data from previous deconstruction projects is compared with the project data and based on past experience with projects having similar characteristics, an initial deconstruction plan is formulated. This may be a detailed listing of steps from beginning to end that must be performed; cost estimates for conducting these procedures; potential facilities that have conducted similar projects before; estimates of time needed to perform the procedures and/or a list of the sequence of procedures for best economy and the like. These can be displayed in a standard spreadsheet format or any other known format to convey the information to the user.

At step 208, a list of potentially recyclable items is compiled and stored in the project database. At step 210, the market value of each item in the list of potentially recyclable items is determined, i.e., from existing databases of the secondary goods market, and at step 212, the market value of each item in the list of potentially recyclable items is compared with the estimated cost of disposal (taken from historical data) of that item. At step 214, a determination is made as to whether the market value exceeds the cost of disposal. If the market value exceeds the cost of disposal, at step 216, the item is added to the recycling (salvage) inventory, and at step 218, a determination is made as to whether or not there are more items in the list of potentially recyclable items to be compared with their market value. If there are not, the process proceeds to step 224, which will be described in more detail below. If, at step 218, there are more items to evaluate, the process proceeds to step 212 and continues to step 214 again.

If, at step 214, it is determined that the market value does not exceed the cost of disposal of a particular potentially recyclable item, the item is added to a disposal (waste) inventory list at step 220. At step 222, a determination is made as to whether or not there are more items to evaluate. If there are, then the process proceeds to step 212 and repeats the above-described process.

If at step 222, there are no more items to evaluate (and similarly, if at step 218 there are no more items to evaluate), at step 224, the initial deconstruction plan developed at step 206 is modified based on the decisions to salvage or dispose of various items. Thus, cost estimates can be revised, procedures required to be performed can be revised, timing estimates can be revised, and the like.

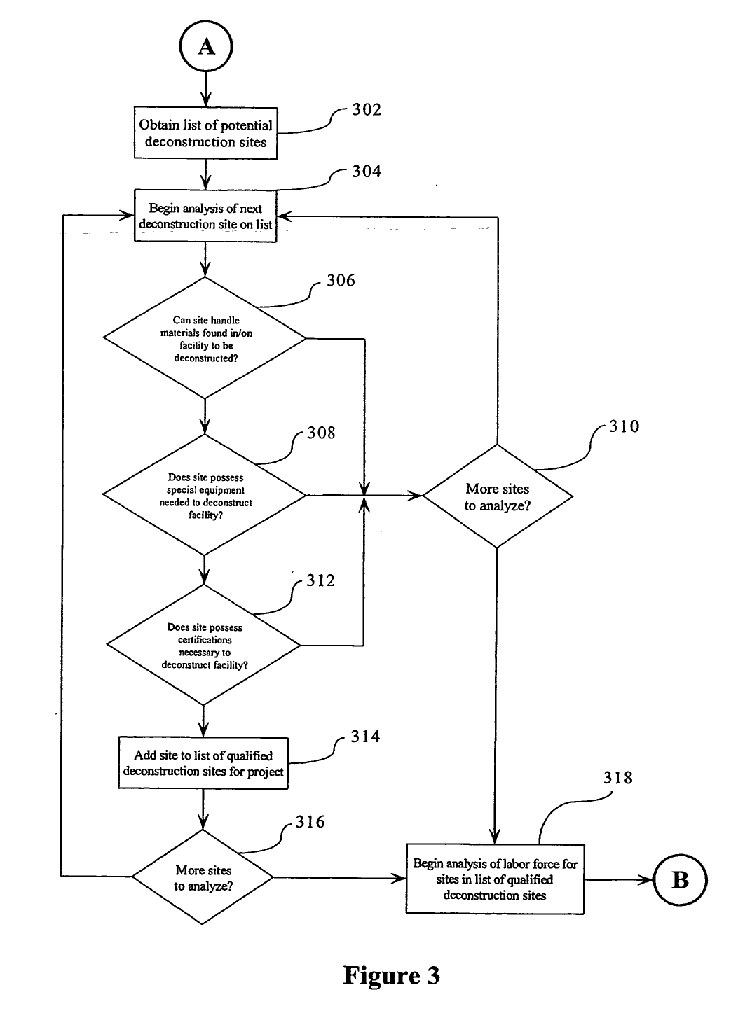

In FIG. 3, the flowchart picks up with the analysis of potential deconstruction sites. Specifically, at step 302, a list of potential deconstruction sites is obtained. This can be input manually or, more preferentially, taken from a list of potential deconstruction sites contained in the historical database or in public record databases. At step 304, the first deconstruction site on the list is analyzed. At step 306, a determination is made as to whether or not the site is equipped to handle the materials found in or on the facility to be deconstructed. If the answer is no, the process proceeds to step 310, where a determination is made as to whether or not more sites are to be analyzed. If there are more sites to be analyzed, the process proceeds back to step 304 and continues. If there are no more sites to analyze, the process proceeds to step 318, which will be described further below.

If at step 306, it is determined that the potential site is equipped (or at least able to be equipped) to handle the materials found in or on the facility to be deconstructed, at step 308, a determination is made as to whether or not the particular site possesses the special equipment needed to deconstruct the facility. This can include drydock facilities, facilities for moving large objects, explosives, torches, and other deconstruction equipment, and the like. If it is found that the facility does not possess the appropriate equipment, the process proceeds to step 310 as described above. If, however, it is determined that the site does possess the special equipment needed, then the process proceeds to step 312, to make sure that the site possesses the necessary certifications to deconstruct the facility. Such certifications may include ISO 14001 certifications regarding environmental requirements, licenses or certifications needed to perform HAZMAT removal and the like. If the site does not possess the necessary certifications/licenses, then the process proceeds to step 310 as described above. If the site does possess these certifications/licenses, the site is added to a list of qualified deconstruction sites for the project at step 314. At step 316, a determination is made as to whether or not there are more sites to analyze. If there are, the process proceeds back to step 304 and the process continues through another iteration. If, however, there are no more sites to analyze, the process proceeds to step 318 and an analysis of the labor force at the qualified deconstruction sites from the list is commenced.

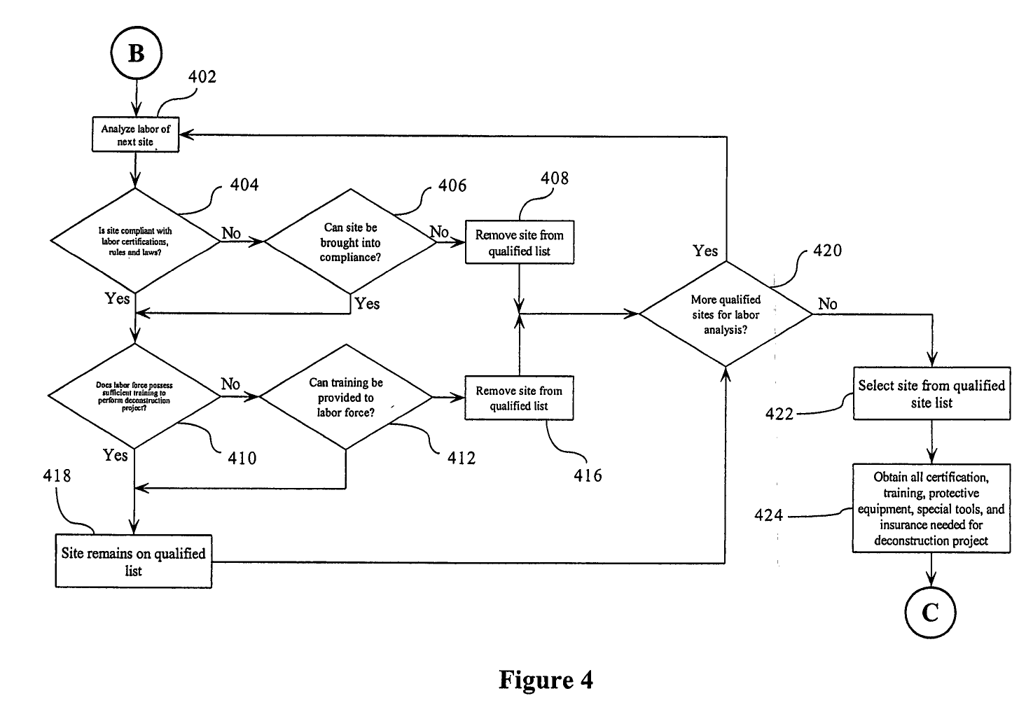

Referring now to FIG. 4, the labor force of a first qualified site is analyzed. At step 404, a determination is made as to whether or not the site has complied with appropriate labor certification rules and laws. If it has not, at step 406, a determination is made as to whether or not the site can be brought into compliance. This may involve the analysis of how difficult and/or time-consuming it will be to bring the site into compliance. In some instances, there may be time thresholds and the like which would require a finding that the site cannot be brought into compliance for the particular project. In any event, at step 406, if it is determined that the site cannot be brought into compliance, at step 408 the site is removed from the qualified list.

If at step 406 it is determined that the site can be brought into compliance, at step 410, a determination is made as to whether or not the labor force at the qualified site possesses sufficient training to perform the deconstruction project. If the labor force does not possess the sufficient training, at step 412, a determination is made as to whether or not the training can be provided to the labor force so that they can perform the deconstruction project. Again, like step 406, certain time and other constraints may require that the site be determined unable to provide the training, e.g., if it would take too long to train the force and still complete the project on time. If at step 412, it is determined that training cannot be provided, at step 416 the site is removed from the qualified list. However, if at step 412 it is determined that training can be provided, then the process proceeds to step 418 where the site remains on the qualified list, and then the process proceeds to step 420 to determine if there are more qualified sites for labor analysis. If there are, the process proceeds to step 402 and the process iterates again.

If there are no more qualified sites for labor analysis, the process proceeds to step 422, where a site is selected from the qualified list. The selection process can be done manually based on scanning or detailed analysis of the various qualified sites, or the process can be done automatically using known decision-making techniques.

Once the site is selected, at step 424, all certification, training, protective equipment, special tools needed for the deconstruction project are obtained and/or implemented so that the deconstruction project can proceed.

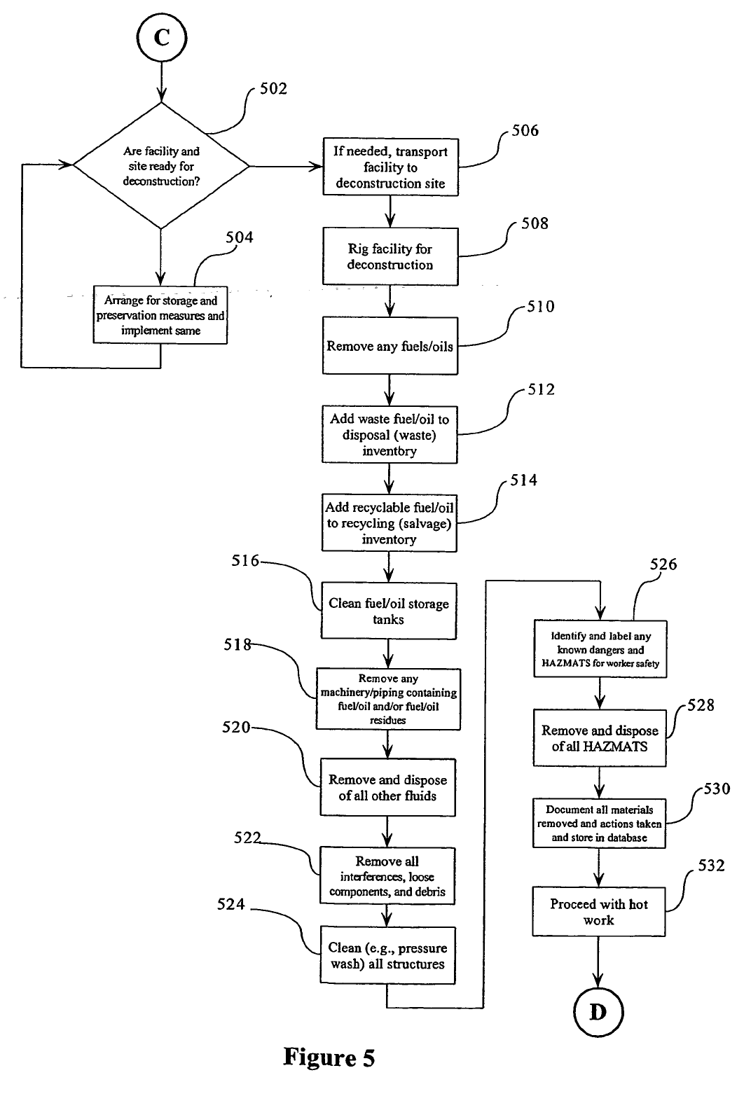

Turning now to FIG. 5, at step 502, a determination is made as to whether or not both the facility and the site chosen are ready to begin the deconstruction process. For example, if certifications need to be acquired before the process can begin, a response to this query will be “no” until such time as the certification information has been obtained and an indication thereof input into the project database. If it is determined at step 502 that the site or the facility is not yet ready for the deconstruction process, at step 504, storage and/or other preservation measures are arranged for and implemented. This might, for example, involve hauling a movable facility to a storage location; drydocking a ship for maintenance prior to deconstruction; and/or replacing or installing protective seals and coverings to protect the facility while waiting for the deconstruction process to begin.

If at step 502 it is determined that the facility and site are ready for deconstruction, the process proceeds to step 506, where if needed, the facility is transported to the deconstruction site, and information pertaining to the completion of this step are input to the project database. Next a series of preliminary matters to be completed prior to the proceeding with hot work are taken care of, and, where appropriate, information regarding their completion is input to the project database so that the status of the facility and the deconstruction process can be monitored. For example, at step 508, the facility is rigged for the deconstruction process. This may involve setting up the equipment and infrastructure necessary for communication, working power, containment of field, structural reinforcement, and air quality and circulation.

At step 510, any fuels, oils or other flammable materials are removed. At step 512, waste fuel/oil is inventoried and indications thereof are included in the waste inventory list. Further, at step 514, recyclable fuel/oil is identified and added to the recycling inventory list. At step 516, the fuel and oil storage tanks can be cleaned; at step 518 machinery and piping containing fuel/oil and/or fuel/oil residues are removed; at step 520, all other fluids are removed and disposed of. Then, at step 522, all interferences (e.g., insulation, cables, and sources of potential health and safety hazards to workers) are removed to enhance the access to other parts of the structure, to avoid fires, and to minimize the release of insulation dust. Loose components and debris are also removed.

At step 524 all structures are cleaned, and at step 525 all known dangers and HAZMATS are labeled for worker safety. At step 528, all HAZMATS are removed and disposed of and an indication thereof is added to the appropriate waste or recycling list.

At step 530, all materials that have been removed and actions taken to dispose of or store them are added to the historical database as well as the project database.

At step 532, the process proceeds to the hot work stage.

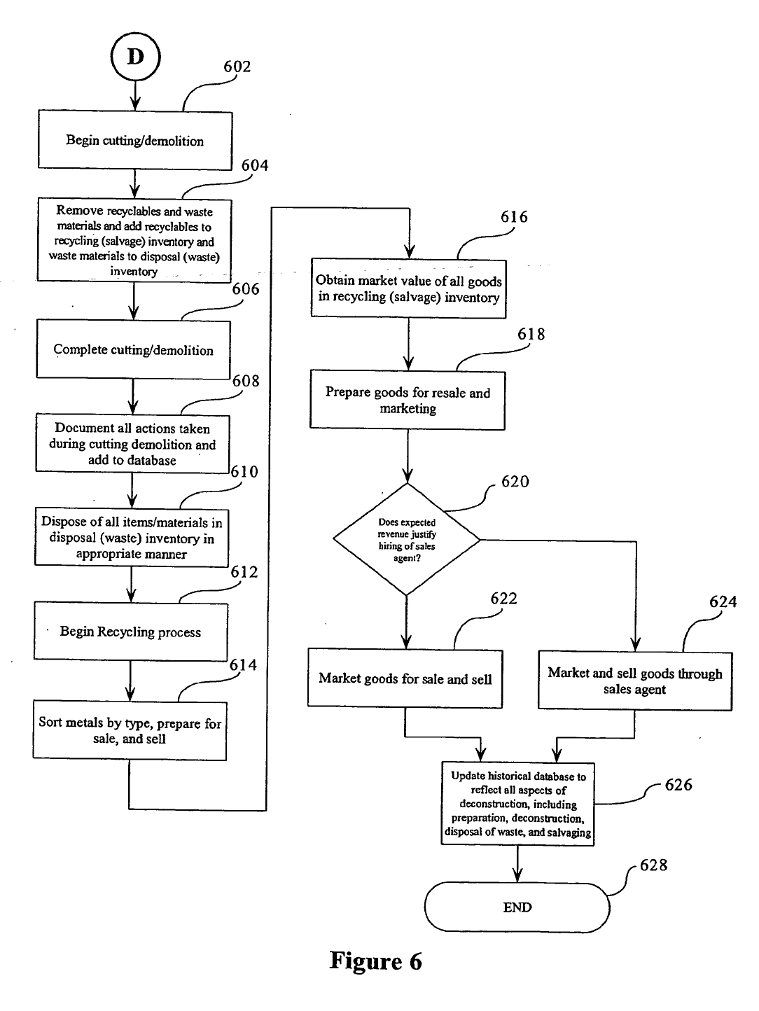

Referring now to FIG. 6, at step 602, the cutting and/or demolition process begins. This will vary depending upon the facility being deconstructed. For example, if a ship is being scrapped, it may be cut into large (e.g., 10-15 ton) modules with torches, shears and explosives. Then the modules are transported via cranes to waste or disposal yards or recycling areas. Aspects of cutting/demolition of a ship are well known and are not considered further here.

If the ship is instead to be reefed, the cutting/demolition steps involve cutting primary cuts into the hull and through the decks, removing waste metals and recycling metals, securing hatches and removing obstacles to divers and the like.

At step 604, all recyclables and waste materials are removed and an indication thereof is added to the appropriate salvage or waste inventory.

At step 606, the cutting/demolition is completed, and at step 608 all actions taken during the cutting and demolition steps are added to the database.

At step 610, all items/materials in the disposal inventory are disposed of in an appropriate manner. At step 612 the recycling process begins. For example, at step 614 metals are sorted by type and prepared for sale and they are sold. At step 616, a market value of all goods in the recycling inventory is obtained and then the items are prepared for resale and marketing at step 618. At step 620, a determination is made as to whether the expected revenue (based on the market value obtained at step 616) justifies the hiring of a sales agent for the resale goods. If a determination is made that the expected revenue does justify the hiring of a sales agent, then the process proceeds to step 624 where the goods are marketed and sold through a sales agent. Alternatively, if at step 620 it is determined that the expected revenue does not justify the hiring of a sales agent, then at step 622 the goods are marketed for sale and resale and sold. At step 626, the historical database is updated to reflect all aspects of deconstruction, including preparation, deconstruction, disposal of waste and salvaging. As noted above, the process can and, in the preferred embodiment, will occur on an ongoing basis, however, at step 626 even if the ongoing process has been followed, a check should be made of the historical database to assure that all steps have been recorded to assure data integrity. Finally, at step 628 the process ends.

One of the key elements of the present invention is the use of databases, the constant updating of databases, and the continued analysis using the databases in connection with the deconstruction planning and implementation process. The invention is not directed to new methods for disposing of waste materials, cutting structures, and the like. Instead, the present invention is an important and novel tool that facilitates the entire process from beginning to end, streamlines the process, and allows sharing of knowledge from prior projects to improve the performance in future projects. Data is obtained and added to a project database which is constantly compared with historical databases and other information described herein to enable a constant improvement of the data and the process itself.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a workstation located at the site where the majority of the deconstruction planning takes place. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

I claim:

1. A computer-implemented method of planning, monitoring, and implementing a deconstruction procedure on a facility, comprising the steps of:
gathering facility data concerning the facility and storing said data in a project database;
comparing the facility data with historical data from a historical database and storing the results of said comparison in said project database;
preparing an initial deconstruction plan based on said comparison and storing said initial deconstruction plan in said project database;
conducting a scrap/recycle analysis on the facility based upon said facility data and said historical data, developing a scrap/recycle plan based on a result of said scrap/recycle analysis, and storing said result and said scrap/recycle plan in said project database;
updating said initial deconstruction plan to incorporate said result and said scrap/recycle plan;
identifying and assessing potential deconstruction sites in view of said updated deconstruction plan and selecting a preferred site to perform the deconstruction;
performing said deconstruction at said selected preferred site and updating said project database as said deconstruction is performed;
executing said scrap/recycling plan; and
updating said project database and said historical database with data pertaining to said performed deconstruction and executed scrap/recycling plan.

2. A system for planning, monitoring, and implementing a deconstruction procedure on a facility, comprising:
means for gathering facility data concerning the facility and storing said data in a project database;
means for comparing the facility data with historical data from a historical database and storing the results of said comparison in said project database;
means for preparing an initial deconstruction plan based on said comparison and storing said initial deconstruction plan in said project database;
means for conducting a scrap/recycle analysis on the facility based upon said facility data and said historical data, developing a scrap/recycle plan based on a result of said scrap/recycle analysis, and storing said result and said scrap/recycle plan in said project database;
means for updating said initial deconstruction plan to incorporate said result and said scrap/recycle plan;
means for identifying and assessing potential deconstruction sites in view of said updated deconstruction plan and selecting a preferred site to perform the deconstruction;
means for performing said deconstruction at said selected preferred site and updating said project database as said deconstruction is performed;
means for executing said scrap/recycling plan; and
means for updating said project database and said historical database with data pertaining to said performed deconstruction and executed scrap/recycling plan.

3. Computer readable code stored on media for planning, monitoring, and implementing a deconstruction procedure on a facility, comprising:
first subprocesses for gathering facility data concerning the facility and storing said data in a project database;
second subprocesses for comparing the facility data with historical data from a historical database and storing the results of said comparison in said project database;
third subprocesses for preparing an initial deconstruction plan based on said comparison and storing said initial deconstruction plan in said project database;
fourth subprocesses for conducting a scrap/recycle analysis on the facility based upon said facility data and said historical data, developing a scrap/recycle plan based on a result of said scrap/recycle analysis, and storing said result and said scrap/recycle plan in said project database;
fifth subprocesses for updating said initial deconstruction plan to incorporate said result and said scrap/recycle plan;
sixth subprocesses for identifying and assessing potential deconstruction sites in view of said updated deconstruction plan and selecting a preferred site to perform the deconstruction;
seventh subprocesses for performing said deconstruction at said selected preferred site and updating said project database as said deconstruction is performed;
eighth subprocesses for executing said scrap/recycling plan; and
and ninth subprocesses for updating said project database and said historical database with data pertaining to said performed deconstruction and executed scrap/recycling plan.
